(19) United States
(12) Patent Application Publication
(10) Pub. No.: US 2016/0379150 A1
(43) Pub. Date: Dec. 29, 2016

(54) ORGANIZATION WELL-BEING SNAPSHOT

(71) Applicant: Humana Inc., Louisville, KY (US)

(72) Inventors: Ryan Igleheart, Louisville, KY (US); Stuart Mushala, Louisville, KY (US); Erik Anderson, Louisville, KY (US)

(73) Assignee: Humana Inc., Louisville, KY (US)

(21) Appl. No.: 14/205,913

(22) Filed: Mar. 12, 2014

Related U.S. Application Data
(60) Provisional application No. 61/785,312, filed on Mar. 14, 2013.

(51) Int. Cl. G06Q 10/06

(52) U.S. Cl. CPC G06Q 10/06393

(57) ABSTRACT

The present disclosure is directed to an organization well-being “snapshot.” The snapshot comprises a comprehensive set of well-being metrics that have been collected and presented for review. In an example embodiment, metrics are determined for the overall well-being and its dimensions of purpose, belonging, health, and security. Each dimension is subdivided in categories and one or more metrics for each category is defined. Data is collected and metrics are calculated for the categories. Metrics are then aggregated to calculate an overall well-being score for an area within the organization as well the entire organization. Methodologies employed in calculating scores facilitate comparisons between areas within the organization and against an enterprise-wide score. The methodologies further support analysis of trends over time. The snapshot presents well-being metrics clearly and effectively in a manner that increases associate awareness of the organization's well-being status and resources that the organization has made available for associates.

### CROSS-REFERENCE TO RELATED APPLICATIONS

The application claims priority to U.S. Provisional Application Ser. No. 61/785,312, filed Mar. 14, 2013 and titled ORGANIZATION WELL-BEING SNAPSHOT, the contents of which is incorporated herein by reference.

### BACKGROUND OF THE INVENTION

Most organizations recognize that to be successful in the marketplace, it is important for the organization to optimize its human capital. Fostering an environment where well-being is enabled can enhance this work because leaders and associates that have a higher sense of well-being and purpose are more likely to be creative and effective in their respective positions and endeavors. If the needs of leaders and associates are met in ways that are consistent with their own values of self-determination, freedom, personal growth, health, and caring as well as accountability, transparency, and responsiveness to the common good of the organization, they are more likely to be successful in their individual capacities and therefore, contribute to the overall success of the organization. To that end, an organization's well-being is largely dependent on the individual's well-being.

Although organization “well-being” is important to the success of an organization, measurement lacks external consensus and continues to provide challenges. One challenge is that while the well-being of an organization is dependent in large part on the individuals that comprise the organization, the well-being of an individual, however, is dependent on several inputs. These include not only their situation and experiences within the organization but also their personal situation and experiences outside the organization. Furthermore, there are numerous ways to measure an individual's well-being. Some methodologies may be more appropriate than others depending upon the needs of the individuals as well as the organization. In addition, while the well-being of each individual in the organization is important in gaining an understanding of the organization's well-being, there are other factors and considerations that may be important to the organization and should be taken into account when attempting to measure the organization's well-being.

In addition to determining an effective measurement of organization well-being, it is important for the organization to communicate the measurement data to the leaders and associates so they can implement changes to increase the “wellness” of the organization. After determining what should be measured and how it should be measured, it is important to share the measurement data throughout the organization. Presenting the data in an effective and meaningful manner is another challenge that must be addressed when attempting to measure and increase organization well-being. Therefore, there is a need for an improved method of measuring organization well-being and presenting organization well-being measurements.

### SUMMARY OF THE INVENTION

The present disclosure is directed to an organization well-being “snapshot.” The snapshot comprises a comprehensive set of well-being metrics that have been collected and presented for review. The organization well-being snapshot provides enterprise and organization leaders with meaningful, actionable metrics that are essential to encourage associates to engage in activities to increase their own well-being. The snapshot is designed to aid in organization learning about how to raise the level of well-being, improve health outcomes, enhance a sense of purpose and belonging, foster better security, advance a culture of health and well-being, and have fun with creative associate-generated ideas that lead to improvement. The snapshot presents well-being metrics clearly and effectively in a manner that increases associate awareness of the organization's well-being status and resources that the organization has made available for associates. The snapshot is further designed to give associates the tools and know-how to consciously manage their own well-being.

To better understand the snapshot, well-being is defined as “living happily with a balanced sense of purpose, belonging, security and health.” Each of these four dimensions of well-being has additional components that create a deeper understanding of the factors that constitute well-being. In an example embodiment, the dimensions are:

TABLE 1
Well-Being Dimensions

| Dimension | Areas of Focus |
|---|---|
| PURPOSE | Vocation |
| Inspiration that guides | Chosen work or activities that complement |
| us to meaningful | your passions, strengths, and expertise. |
| activities that bring | Advocacy |
| joy to our lives. | Being fully invested in a cause or idea, |
| | and actively promoting it. |
| | Service |
| | Actions and support for the care and |
| | advancement of others. |
| BELONGING | Social |
| Presence of meaningful | A sense of acceptance and connection |
| relationships in your life | through positive relationships. |
| and connections with | Community |
| chosen communities. | Joint together with others who share a |
| | common interest. |
| | Family |
| | Surrounding yourself with those one cares |
| | about and who care about you. |
| SECURITY | Financial |
| Security is the feeling | Having enough money for basic needs, |
| of being safe and the | making progress on your standard of |
| assurance that you | living and making short-term financial |
| are protected. | decisions that lead to long-term financial |
| | security |
| | Personal Safety |
| | Being free from the fear of danger, risk |
| | or injury to yourself or your loved ones. |
| | Environmental |
| | Having sustainable resources necessary |
| | to enable you to meet basic daily needs |
| | and focus on a higher purpose. |
| HEALTH | Physical |
| Health is having the | Having a level of fitness necessary to |
| energy, physical | perform daily activities and duties with vitality. |
| freedom and desire to | Emotional |
| thrive in living your | Able to maintain a balanced perspective |
| purpose every day. | while managing the demands of life. |
| | Spiritual |
| | A strong connection to the essence of |
| | one's being related to the beliefs, values |
| | and practices (whether religious or non- |
| | religious) by which they live. |

### BRIEF DESCRIPTION OF THE DRAWINGS

FIGS. 1A and 1B are a description of snapshot metrics for an organization well-being snapshot according to an example embodiment;

FIG. 2 is a description of metrics for aggregate score calculation according to an example embodiment; and

FIGS. 3 and 4 are sample snapshots according to an example embodiment.

### DETAILED DESCRIPTION

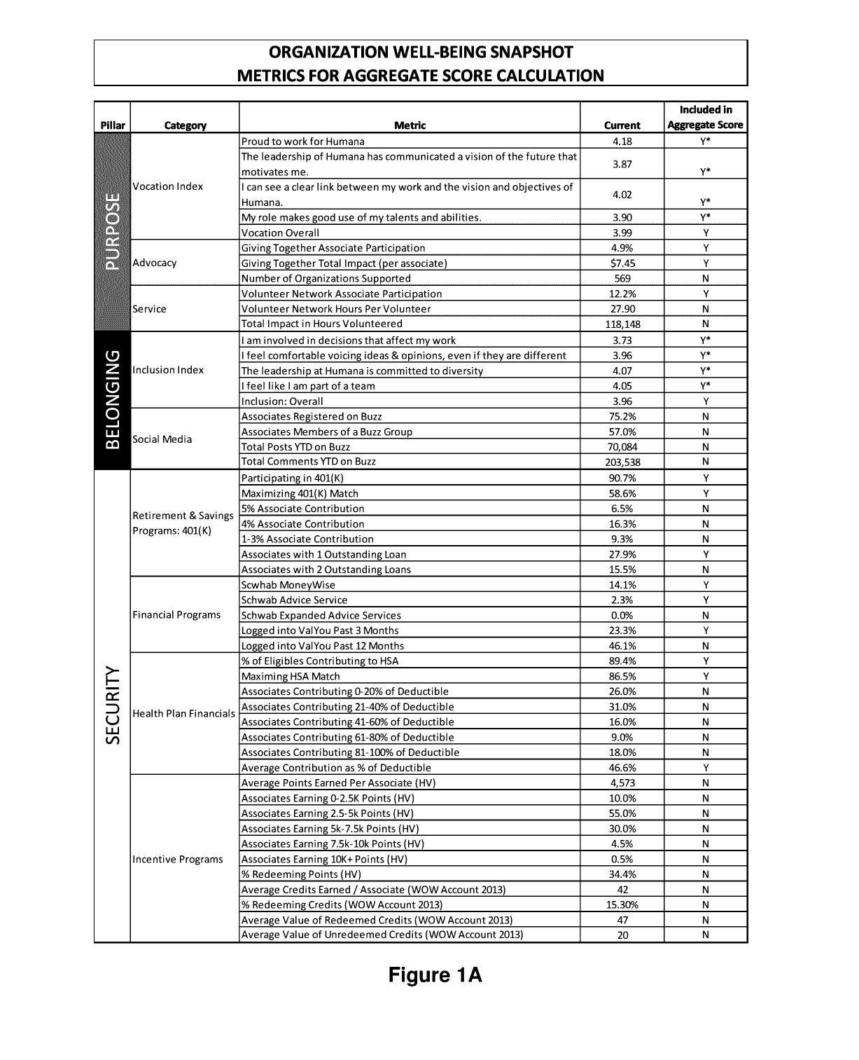

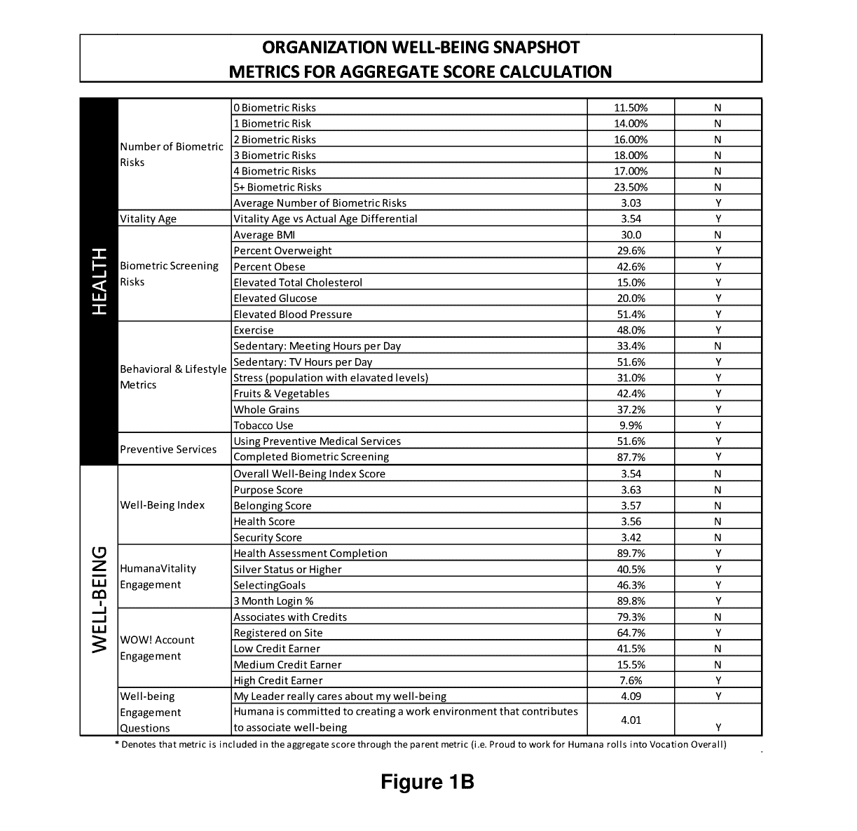

Referring to FIGS. 1A and 1B, a description of snapshot metrics for an organization well-being snapshot according to an example embodiment is shown. In an example embodiment, a comprehensive set of approximately 150 well-being metrics is collected and presented for review. These metrics may be identified and selected for inclusion in a snapshot through a consultative and collaborative process with multiple business divisions or units in an organization. To enhance the utility and functionality of the snapshot, greater consideration may be placed on metrics that leaders can affect. For a company in the health industry, such as a health benefits provider, metrics centered on health are generally more robust and offer a wider array of actionable information. The snapshot metrics are “actionable” so that organization leaders have data that may be used to encourage associates to engage in activities to increase their own well-being. As indicated in the last column of the list, some metrics may be included in an aggregate score that is reported on the snapshot while others are collected but do not necessarily contribute the snapshot.

One way for leaders to inspire their associates' commitment to well-being is by role modeling healthy practices and habits and by sharing aspects of their own well-being stories. Revealing a little bit about one's own experience seems to create trust and opens the dialogue with those who wish to participate. In addition to facilitating dialogue, the snapshot is designed to aid in organization learning about how to raise the level of well-being, improve health outcomes, enhance a sense of purpose and belonging, foster better security, advance a culture of health and well-being, and have fun with creative associate-generated ideas that lead to improvement.

Just as it is widely known that people's personal levels of well-being vary, well-being also varies by organization. Comparing the well-being status among divisions or units in an organization may be helpful to the organization in developing strategies to enhance well-being. For this reason, a snapshot as disclosed has comparative features that show a division's or unit's measure (Your Area) compared to the enterprise-wide measure (The Organization).

The snapshot presents well-being metrics clearly and effectively in a manner that increases associate awareness of the organization's well-being status and resources that the organization has made available for associates. The snapshot is further designed to give associates the tools and know-how to consciously manage their own well-being.

An important consideration for a well-being snapshot as disclosed is privacy. Extensive amounts of personal data are used to compile a snapshot as disclosed. Consequently, privacy is at the forefront of every aspect of the design. One important element of trust is respect of an individual's privacy. Relationships are built on this trust. Because the snapshot contains aggregate data at the organization level, protecting sensitive individual level data is paramount. Attention to privacy concerns is important to ensure that associates are comfortable with the ways in which data is collected and shared. Significant standards and safeguards must be instituted in protecting all individual data during the snapshot creation and dissemination. This requirement is particularly important for all data related to health and financials.

It is important for an organization to develop and follow a stringent privacy policy before undertaking a snapshot development effect. In an example embodiment, to protect the privacy of participating associates, data is reported for groups of at least 100 associates. This number both protects the privacy of the individual level data when aggregated but also provides a meaningful sample from which inferences can be made at the organization and enterprise level.

A variety of metrics for which data is available may be considered in the development of the snapshot. Many metrics relate to a facet of a well-being framework. Well-being data may be gathered from numerous, available sources. Not all of the data must be from the same year and updates of these data may occur at different times during any given year. Appendix A comprises a definitions and terms section and a complete description of the data source and years covered. For the example snapshots in the present disclosure, data was drawn from 2013.

Consideration for data selection and mapping may be summarized as follows:
Data relevant to well-being;
Available data at the individual level;
Available data for reporting at the organization level; and
Appropriate actionable data to share with leaders that adheres to the organization's privacy policy.

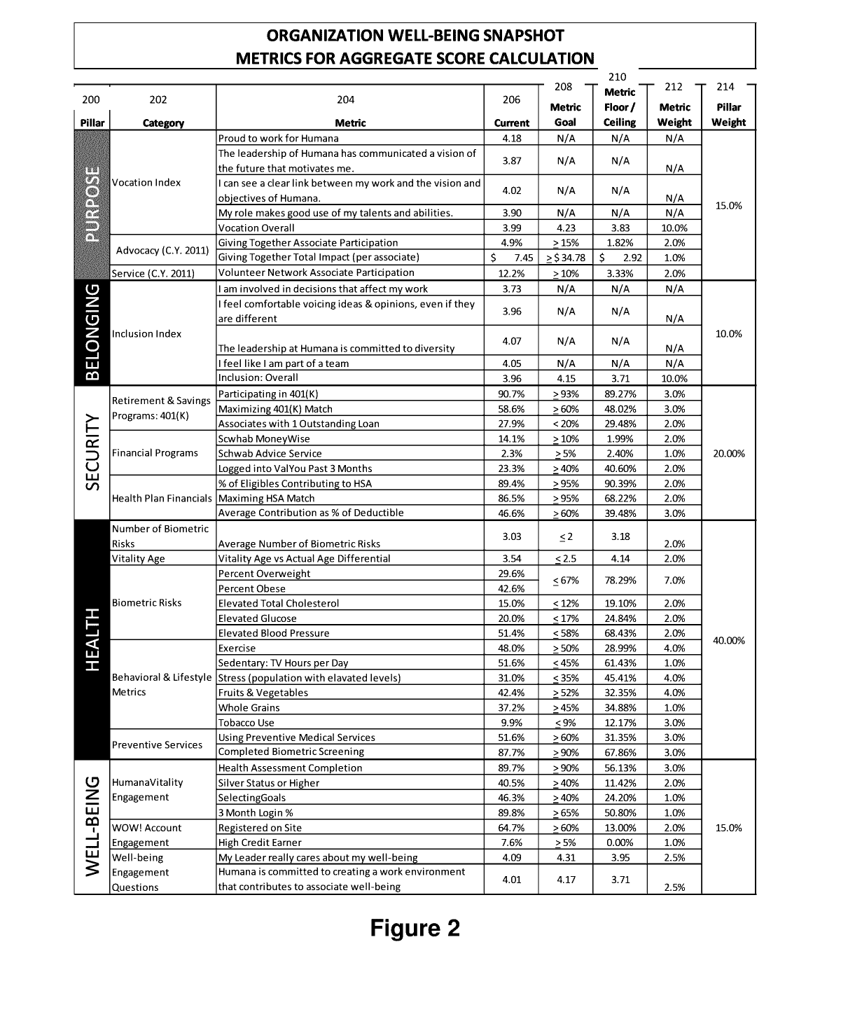

Referring to FIG. 2, a description of metrics for aggregate score calculation according to an example embodiment is shown. Each dimension or pillar 200 to be measured is subdivided into a plurality of categories 202 (e.g., purpose/vocation index; purpose/advocacy; belonging/inclusion index) and within each category, one or more metrics is defined (e.g., purpose/vocation index/proud to work for company; purpose/advocacy/giving together associate participation; belonging/inclusion index/I am involved in decisions that affect my work). When calculating an aggregate score, dimensions or pillars may be weighted differently 214 depending upon the needs of the organization and which metrics the organization wants to emphasize.

One or more metrics 204 is defined for each category. A metric goal or upper limit 208, a metric floor or lower limit 210, and metric weight (sum of each metric weight within a dimension comprises the total dimension weight) 212 may be set for each metric 204. (See Appendix for definitions). A current value (actual measured value) for each metric 206 is shown in the description. In an example embodiment, a metric goal may be determined in one of two ways: 1) goals may be set around the organization's population health strategy, including biometric risks and behavioral and lifestyle metrics; and 2) goals may be related to specific programs as determined by leaders, program owners/vendors, subject matter experts, etc. For example, a group that administers a volunteer program for the organization may determine a metric goal for the group.

In an example embodiment, the aggregate score is derived by combining weighted measures 214 that comprise the organization's well-being environment and four dimensions of well-being: Purpose; Belonging; Security; and Health. The score is an objective measure that allows leaders to quickly understand how their organization's collective well-being is progressing relative to the weighted measures 214. The score also makes it possible to rank leaders that qualify for a snapshot on their level of well-being relative to other qualifying organization leaders. Because it is a relative measure, the aggregate score does not answer questions such as: “Is this organization good or bad” but instead addresses questions such as “relative to others, how is our organization's well-being?” An aggregate score is very valuable but also challenging to construct because it involves incorporating disparate data from the four dimensions of well-being into a measure that is meaningful and fair for purposes of determining the objective well-being status of each organization.

Multiple aggregate scoring methods may be considered in developing the one on which the aggregate score of the snapshot is based. Four primary methods to consider include: Analytic Scoring; Analytic Scoring with Spectrum; Analytic Scoring with Standard Deviation; and Quartile Scoring.

Analytic Scoring: This method is traditionally employed by instructors to grade writing assignment as writing is viewed as demonstrating disparate skills that need to be graded separately and then added together to yield an evaluation that is both appropriate and fair. In essence, the analytic score comprises disparate scores that are often weighted by relative importance of each feature being graded. A variation of this method may be used during the development of an aggregate score. In an example embodiment, the method utilizes a six-step process that allocates weighted points based on a five-point scale (0, 1, 2, 3, and 4) with each scale, except for zero, representing 25% of the total possible points for that metric. Other point values or point scales may be used depending upon the needs of the organization. For this scoring method, the floor may be based on a subjective decision of what constitutes a minimal acceptable scoring level. For instance, if the organization determines that the lowest possible response on an engagement survey is a three (neutral), any responses lower than neutral (which are “disagree” and “strongly disagree”) receive zero points. This method may not be appropriate in some instances due to the inherent subjective nature of defining the point thresholds.

Analytic Scoring with Spectrum: Similar in many ways to the analytic scoring method, a second method creates a spectrum where the floor for each metric is determined by the lowest performing organization. Along the distribution spectrum for that metric, points are allocated on a linear scale. The lowest performing organization, the floor, receives 0% of eligible points while those that scored at or above the organization goal receive 100% of the eligible points. All organizations lying between the floor and goal receive a proportionate number of points relative to their point percentage away from the goal. For example, if the floor stands at 75% participation in a program and the established goal is 90%, an organization at 85% participation in the program is allocated 66.67% of the eligible points for that metric ([85%−75%]/[90%−75%]). While this method is typically the most inclusive, it is also susceptible to outliers with respect to the metric floors. Such a shortcoming necessitated by an outlier could theoretically boost the scores of other organizations merely because the floor is set too low thereby minimizing the utility of comparisons.

Analytic Scoring with Standard Deviation: To address the drawbacks of the Analytic Scoring with Spectrum method, a standard deviation method may be used. This method utilizes the standard deviation of each metric and subtracts that from the mean (or adds it to the mean for those metrics that are negative indicators such as elevated blood pressure) to create the floor. From a statistical perspective, this approach places approximately 15-17% of all organizations at or below the floor resulting in zero point allocation for these organizations below the floor for a given metric. Even though this method mitigates the effects of outliers, its complexity and accompanying explanatory challenges may not be appropriate for some organizations.

Quartile Scoring: Similar to the standard deviation methods, the quartile approach mitigates the outliers and places the lowest performing quartile of organizations at or below the floor. In an example embodiment, computations are based on establishing metric quartiles that serve as the floors. For example, if the lowest participation rate of a given metric is 75% but the lower quartile range stands at 78%, the floor is set at the latter figure. Any organization at or below 78% thus receives zero points. The floor may be held constant going forward to facilitate trending. Points are then allocated on a linear basis with those organizations at or below the floor credited with 0% of eligible points while those at or above the goal credited 100% of the eligible points. Organizations that fall in between receive proportionate credit relative to their position between the metric floor and goal. For example, if an organization experienced a participation rate of 85% and the goal for that that particular metric was set at 90%, that organization receives 58.3% of the eligible points for that metric ([85%−78%]/[90%−78%]).

In each of the aforementioned methods, the goal is the ceiling (level at which 100% of eligible points are allocated) for each metric. This modality has the advantage of encouraging organizations to strive to reach the set goals and not to fall below the floor which, by loose definition, is the lowest acceptable position at which an organization can be. No additional or bonus credits are possible or awarded. Prior to calculating the score, metrics are expressed in values that are comparable with each other. For example, the metrics may be converted to percentages.

In summary, the scoring method that is employed for an example embodiment of the snapshot is as follows.
1. Full points awarded for organizations that are at or above the goal. Otherwise, zero points awarded for organizations at the lowest quartile. Because this floor (lower quartile) is held constant going forward, it avoids potential issues with organizations not having the opportunity to improve if they are always in the bottom quartile. The quartile method supports a “meeting a bare minimum requirement” because an arbitrary value is not set as the minimum acceptable level but everything at baseline is relative to the enterprise and its internal organizations.
2. Resistant to outliers.
3. The scoring criteria make the assignment of points straightforward.
4. Organizations understand the grading criteria. If the organization is at or above the goal, it is awarded full points. If the organization is below the established “unmoving floor,” it is not awarded any points. If the organization is in between, it is awarded proportionate points for the in-between values.
5. The distribution or assigning of points is not arbitrary.
6. Because the quartile measurements are relative to the organizations under consideration, a poorly performing organization may appear to be better than it is by general standards. For example, if most organizations have an overweight and obese rate of 90% but one organization has a rate of 75%; it appears to be better than the other organizations even though the rate is clearly undesirable.

In calculating aggregate scores, certain metrics may be weighted more than others. For example, metrics relevant to the organizations core business may be weighted more than other metrics. For organizations in the health industry such as a health benefits provider, health metrics may be assigned a greater weight than the other metrics on the snapshot. Engagement may be assigned the next highest weight (in purpose and belonging), followed by security, well-being, and the non-engagement aspects of purpose. The measure for which change is desired may be the one that the organization weights the highest. Because dimensions are divided into sub-categories, organizations may make improvements in any dimensional component and still observe positive change in scores.

In an example embodiment, the aggregate score calculation is a two-stage and multi-step process using sound statistical methods. The first stage in the process is divided into multiple phases as follows:

TABLE 2
Aggregate Score Calculation: Stage 1

| Step | Description |
|---|---|
| Determine and set the | The goals may be provided by program owners |
| goals for each metric. | or developed through collaboration with |
| | internal subject matter experts and approved |
| | by senior leaders who oversee the health and |
| | well-being of associates. |
| Categorize the data into | The floor is held constant going forward for |
| quartiles such that the | trending purposes and provides organizations |
| lowest quartile for each | with an opportunity to observe score increases |
| metric serves as the | as they work toward improvements in their |
| floor | organization's well-being. |

The second stage involves multiple straightforward steps that calculate a score for each metric that comprise the aggregate score. This computation for the aggregate score is based upon the following factors:

TABLE 3
Aggregate Score Calculation: Stage 2

| Step | Description |
|---|---|
| Metric | Sum of each metric weight within a dimension comprises |
| Weight | the total dimension weight. For example, the belonging |
| | dimension comprises four metrics that sum to the |
| | dimension weight and are weighted equally. |
| Goal | Goals are set by the program owners and subject |
| | matter experts |
| Current | Actual measured value for an organization |
| Metric | |
| Measure | |
| Lower | Calculated lower quartile value |
| Quartile | |
| Quartile | Depends on whether the metric measures a positive |
| Range | or negative item. If positive (a measure that should be |
| Limit | increased e.g., participation in the 401(k) program), the |
| | limit is the lower quartile. If negative (a measure that |
| | should be decreased e.g., elevated blood pressure), |
| | the limit is the upper quartile. |

The computation of the above metrics yields a calculated dimension score. A summation of the calculated dimension scores forms an aggregate score as indicated in the goal floor weighting values shown in FIG. 2. This score ranges between 0 and 100. Intuitively, higher numbers are better than lower numbers. The aggregate scores can also be rank order to produce the ranks that are reported on the snapshot.

Unlike other aggregate scores, the proposed metrics and rankings can be compared over time because the floor, and to some extent the ceiling/goal, are held constant thus allowing for a direct trend comparison. Leaders are also able to observe and understand the magnitude of their organization's improvements or regressions because the snapshot allows them to see the dimensions in which they improved or did not improve. The design of the snapshot provides many business opportunities because it can be applied and utilized by other employer groups with a comparable set of metrics.

The proposed aggregate score is based on valid and proven methods. The process for constructing the aggregate score is psychometrically sound, valid, reliable, and expertly thoughtful (legitimacy because goals are set by program owners; valid and psychometrically sound because process and computations are based on science and math; reliable because results can be consistently replicated for any organizations that have the requisite data; and expertly thoughtful because everything is based on the best available knowledge from subject matter expert and business leaders). The aggregate score is derived from a set of computations and procedures that consistently yield similar results for any organization when correctly applied. It measures how organizations are doing on total well-being relative to peers.

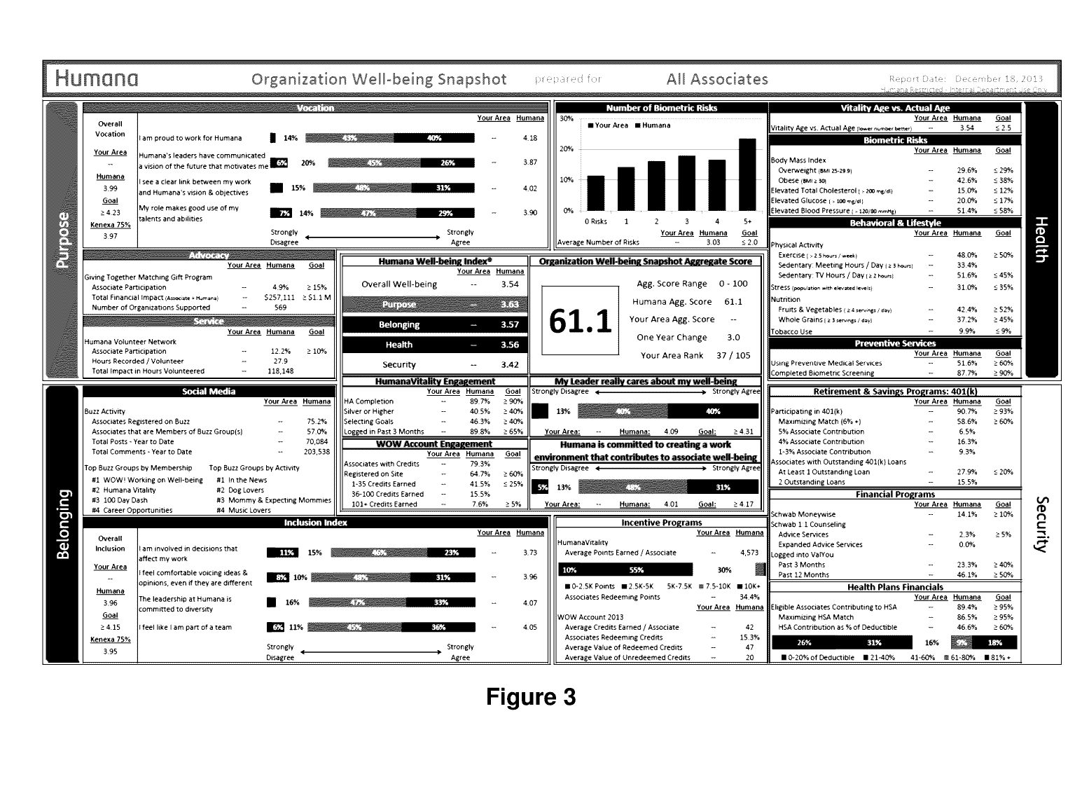

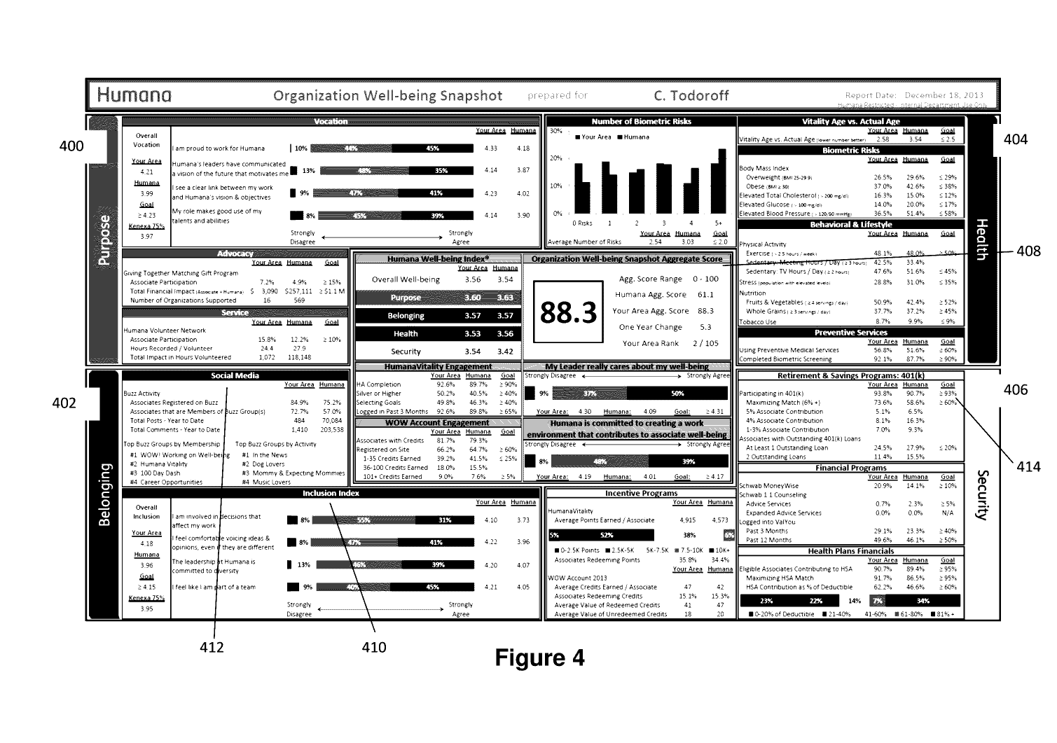

Referring to FIGS. 3 and 4, sample snapshots according to an example embodiment are shown. Referring to FIG. 4, the snapshot may be comprised of approximately 150 data points. In an example embodiment of a snapshot layout, the measured dimensions are incorporated (e.g., the four dimensions of well-being: Purpose 400; Belonging 402; Security 404; and Health 406) encircling well-being at the core 408 to emphasize the interactions between the four dimensions with one another as well as overall well-being.

Many of the metrics roll up into a composite measure such as the Inclusion Index 410. The composite measure is the basis against which the metric goal is measured. There are a number of measures on the snapshot such as Buzz utilization 412 that are included for informative purposes. These informative metrics may not have specific goals attached to them. Nevertheless, they help to provide a clear picture of the organization's well-being framework. Similarly, the desired state of 401(k) contributions has a goal attached to it 414 while the other contribution levels may be included for the above mentioned reason.

An organization that wants to be successful in the marketplace, particularly in the healthcare industry, needs to first embrace and emulate well-being internally. The snapshot is one facet of a well-being movement that may stir associates, leaders, and organizations into active dialogue around the current state of well-being at an organization and how improvements can be achieved.

While certain embodiments of the disclosed organization well-being snapshot are described in detail above, the scope of the invention is not to be considered limited by such disclosure, and modifications are possible without departing from the spirit of the invention as evidenced by the claims. For example, elements of the snapshot layout and the metrics appearing on the snapshot may be varied and fall within the scope of the claimed invention. Various aspects of data collection and metric calculations may be varied and fall within the scope of the claimed invention. One skilled in the art would recognize that such modifications are possible without departing from the scope of the claimed invention.

1. A computerized method for calculating an organization well-being measurement comprising:
(a) receiving at a computer score data for a plurality of group scores comprising for each group score:
(1) a group score identifier; and
(2) a group score value based on data for a plurality of members of said organization;
(b) defining at said computer an upper limit for each of said plurality of group scores;
(c) defining at said computer a lower limit for each of said plurality of group scores;
(d) defining at said computer a point scale comprising a plurality of point values;
(e) assigning at said computer to each of said plurality of group scores:
(1) a highest point value if said group score is equal to or is greater than said upper limit;
(2) a proportional point value if said group score is less than said upper limit and is greater than said lower limit; and
(3) zero point value if said group score is equal to or less than said lower limit; and
(f) calculating at said computer for said organization an aggregate score by totaling said highest and proportional point values assigned to said group scores.

2. The computerized method of claim 1 wherein said plurality of members comprises every member of said organization.

3. The computerized method of claim 1 wherein said plurality of members comprises less than every member of said organization.

4. The computerized method of claim 1 wherein said group score value represents a participation rate.

5. The computerized method of claim 1 wherein said participation rate is a participation rate in a program selected from the group consisting of: advocacy programs, service programs, retirement programs, saving programs, financial programs, health programs, health plans, employee surveys, and reward programs.

6. The computerized method of claim 1 wherein said group score value represents an aggregate of member reported scores.

7. The computerized method of claim 1 wherein calculating for said organization an aggregate score comprises weighting said group scores before totaling said scores.

8. A computerized method for calculating and presenting an organization well-being measurement comprising:
(a) receiving at a computer score data for a first plurality of group scores comprising for each group score:
(1) a group score identifier; and
(2) a group score value based on data for all members of said organization;
(b) calculating at said computer a first aggregate score by combining said first plurality of group scores;
(c) receiving at said computer score data for a second plurality of group scores comprising for each group score:
(1) a group score identifier; and
(2) a group score value based on data for a group of members within said organization;
(d) calculating at said computer a second aggregate score by combining said second plurality of group scores; and
(e) generating at said computer a display comprising:
(1) said first aggregate score representative of well-being for all members of said organization; and
(2) said second aggregate score representative of well-being for said group within said organization.

9. The computerized method of claim 8 wherein calculating a first or second aggregate score comprises:
(a) defining at said computer an upper limit for each of said plurality of group scores;
(b) defining at said computer a lower limit for each of said plurality of group scores;
(c) defining at said computer a point scale comprising a plurality of point values;
(d) assigning at said computer to each of said plurality of group scores:
(1) a highest point value if said group score is equal to or is greater than said upper limit;
(2) a proportional point value if said group score is less than said upper limit and is greater than said lower limit; and
(3) zero point value if said group score is equal to or less than said lower limit;
(e) calculating at said computer an aggregate score by totaling said highest and proportional point values assigned to said group scores.

10. The computerized method of claim 9 wherein calculating at said computer an aggregate score comprises weighting said group scores before totaling said scores.

11. The computerized method of claim 8 wherein said group score value represents a participation rate.

12. The computerized method of claim 11 wherein said participation rate is a participation rate in a program selected from the group consisting of:
advocacy programs, services programs, retirement programs, saving programs, financial programs, health programs, health plans, and reward programs.

13. The computerized method of claim 8 wherein said group score value represents an aggregate of member reported scores.

14. A computerized system for calculating an organization well-being measurement comprising:
(a) a computerized database storing:
(1) score data for a plurality of group scores wherein said group score data comprises:
(i) a group score identifier; and
(ii) a group score value based on data for a plurality of members of said organization;
(2) limit data comprising:
(i) an upper limit for each of said plurality of group scores;
(ii) a lower limit for each of said plurality of group scores;
(3) a point scale comprising a plurality of point values;
(b) one or more computers executing programming instructions to:
(1) assign to each of said plurality of group scores:
(i) a highest point value if said group score is equal to or is greater than said upper limit;
(ii) a proportional point value if said group score is less than said upper limit and is greater than said lower limit; and
(iii) zero point value if said group score is equal to or less than said lower limit; and
(2) calculate for said organization an aggregate score by totaling said highest and proportional point values assigned to said group scores.

15. The computerized system of claim 14 wherein said plurality of members comprises every member of said organization.

16. The computerized system of claim 14 wherein said plurality of members comprises less than every member of said organization.

17. The computerized system of claim 14 wherein said group score value represents a participation rate.

18. The computerized system of claim 14 wherein said participation rate is a participation rate in a program selected from the group consisting of:
advocacy programs, service programs, retirement programs, saving programs, financial programs, health programs, health plans, employee surveys, and reward programs.

19. The computerized system of claim 14 wherein said group score value represents an aggregate of member reported scores.

20. The computerized system of claim 14 wherein the instruction to calculate an aggregate score comprises an instruction to weight said group scores before totaling said scores.
